(19) United States
(12) Patent Application Publication
(10) Pub. No.: US 2007/0010614 A1
(43) Pub. Date: Jan. 11, 2007

(54) Vinyl polymer composition, vinyl composition tile formulation and vinyl composition tile

(76) Inventors: Kenneth J. Faust, Bath, PA (US); Mary Katherine Dyczko, Penns Grove, NJ (US)

Correspondence Address: KILYK & BOWERSOX, P.L.L.C., 400 HOLIDAY COURT, SUITE 102, WARRENTON, VA, 20186, US

(21) Appl. No.: 11/483,132

(22) Filed: Jul. 7, 2006

Related U.S. Application Data
(60) Provisional application No. 60/697,405, filed on Jul. 8, 2005.

(51) Int. Cl. C09B 67/00

(52) U.S. Cl. 524/502

(57) ABSTRACT

A composition is described that includes a vinyl chloride homopolymer and a vinyl copolymer, wherein the vinyl chloride homopolymer is present in the composition in an amount greater than 50% by weight of the combined amount of vinyl chloride homopolymer and a vinyl copolymer. The composition can include at least one filler, at least one plasticizer, and/or at least one stabilizer to form a vinyl composition tile formulation, which can be formed into a vinyl composition tile. Other compositions and tiles are described.

This application claims the benefit under 35 U.S.C. §119(e) of prior U.S. Provisional Patent Application No. 60/697,405, filed Jul. 8, 2005, which is incorporated in its entirety by reference herein.

### BACKGROUND OF THE INVENTION

The present invention relates to a vinyl polymer composition which can be used to form surface coverings, such as floor coverings, like resilient flooring material. In particular, the invention relates to composition comprising a homopolymer of vinyl chloride and a vinyl polymer, like a copolymer of vinyl chloride-vinyl acetate, in which the amount of homopolymer is greater than the amount of copolymer. The present invention further relates to vinyl composition tile (VCT) formulations containing a vinyl polymer composition of the present invention, and to a vinyl composition tile made from the compositions.

Various types of compositions containing vinyl chloride polymers and copolymers have been utilized in the flooring industry. Typical compositions have included compositions containing 100% vinyl chloride-vinyl acetate copolymer or compositions containing vinyl chloride-vinyl acetate and a relatively small amount of vinyl chloride homopolymer. Although vinyl chloride-vinyl acetate copolymer is more expensive than vinyl chloride homopolymer, it has typically been the case that increasing the amount of vinyl chloride homopolymer leads to an increase in the processing temperatures required to form a vinyl composition tile, offsetting any cost advantages from the use of the homopolymer. Moreover, when attempts have been made to form a vinyl composition tile using an increased amount of a conventional vinyl chloride homopolymer, it has been found that the homopolymer lacks cohesiveness and that tiles made with the increased amount of homopolymer have an increased tendency to fall apart. Moreover, it was found that vinyl composition tile formulations containing an increased amount of vinyl chloride homopolymer have an increased tendency to burning and discoloration. Accordingly, the use of more than a minor amount of vinyl chloride homopolymer in a vinyl composition for forming a vinyl composition tile has been discouraged, and the upper limit on the amount of vinyl chloride homopolymer that can be contained in a composition of a homopolymer of vinyl chloride and a copolymer of vinyl chloride-vinyl acetate has typically been considered to be 40-45% by weight or less of the combined amount of vinyl chloride homopolymer and a vinyl chloride-vinyl acetate copolymer.

However, the rising cost and occasional unavailability of the vinyl chloride-vinyl acetate copolymer has been difficult to the surface covering industry.

Accordingly, there is a need to provide a vinyl polymer composition that can be processed into a vinyl composition tile at a lower cost.

Further, there is a need to provide a vinyl polymer composition in which the amount of vinyl chloride-vinyl acetate copolymer in the composition can be minimized or eliminated.

Further, there is a need to provide a vinyl polymer composition in which the amount of vinyl chloride homopolymer in the composition can be maximized.

Further, there is a need to provide a vinyl polymer composition containing vinyl chloride homopolymer as the primary polymer and wherein the composition can be processed into a vinyl composition tile at a processing temperature and processing cost comparable to a vinyl composition containing vinyl chloride-vinyl acetate copolymer as the primary polymer.

### SUMMARY OF THE INVENTION

A feature of the present invention is to provide a vinyl polymer composition that can be processed into a vinyl composition tile at a low cost.

Another feature of the present invention is to provide a vinyl polymer composition in which the amount of vinyl chloride-vinyl acetate copolymer or other vinyl copolymer in the composition can be minimized or eliminated.

Still another feature of the present invention is to provide a vinyl polymer composition in which the amount of vinyl chloride homopolymer in the composition can be maximized without a loss of cohesiveness.

Still another feature of the present invention is to provide a vinyl composition tile formulation containing a stabilizer that reduces the likelihood of burning and discoloration when the vinyl composition tile formulation is processed into a vinyl composition tile.

Still another feature of the present invention is to provide a vinyl polymer composition containing vinyl chloride homopolymer as the primary polymer and wherein the composition can be processed into a vinyl composition tile at a processing temperature and processing cost comparable to a vinyl composition containing vinyl chloride-vinyl acetate copolymer as the primary polymer.

Additional features and advantages of the present invention will be set forth in the description which follows, and, in part, will be apparent from the description, or may be learned by practice of the present invention. The features and other advantages of the present invention will be realized and attained by means of the elements and combinations particularly pointed out in the written description and the claims.

To achieve these and other advantages, and in accordance with the purposes of the present invention as embodied and broadly described herein, the present invention relates to a composition comprising a vinyl chloride homopolymer and a vinyl copolymer, such as a vinyl chloride-vinyl acetate copolymer, wherein the vinyl chloride homopolymer is present in the composition in an amount greater than 50% by weight of the combined amount of vinyl chloride homopolymer and a vinyl copolymer, such as a vinyl chloride-vinyl acetate copolymer. For purposes of the present invention, the preferred vinyl copolymer, namely vinyl chloride-vinyl acetate copolymer, will be discussed. However, for purposes of the present invention, and in all embodiments of the present invention, the copolymer can be any vinyl copolymer suitable for use in forming tiles and, therefore, the present invention relates to minimizing or eliminating the vinyl copolymer. For purposes of the present invention, the vinyl copolymer includes copolymers, terpolymers, and the like. The amount of vinyl chloride homopolymer may be 80% or greater by weight of the combined amount of vinyl chloride homopolymer and vinyl chloride-vinyl acetate copolymer, or may be 80%-99% by weight of the combined amount of vinyl chloride homopolymer and vinyl chloride-vinyl acetate copolymer or may be 80%-90% by weight of the combined amount of vinyl chloride homopolymer and vinyl chloride-vinyl acetate copolymer. In one embodiment, the vinyl chloride homopolymer can have a K-value of 54 or less, for example, from about 47 to about 51.

The present teachings further relate to a vinyl composition tile formulation comprising a vinyl chloride homopolymer, a vinyl chloride-vinyl acetate copolymer, at least one plasticizer, at least one stabilizer and at least one filler, wherein the vinyl chloride homopolymer is present in the formulation in an amount greater than 50% by weight of the combined amount of vinyl chloride homopolymer and a vinyl chloride-vinyl acetate copolymer. The amount of vinyl chloride homopolymer may be 60% or greater or 70% or greater, by weight of the combined amount of vinyl chloride homopolymer and vinyl chloride-vinyl acetate copolymer, or may be 80%-99% by weight of the combined amount of vinyl chloride homopolymer and vinyl chloride-vinyl acetate copolymer or may be 80%-90% by weight of the combined amount of vinyl chloride homopolymer and vinyl chloride-vinyl acetate copolymer. The vinyl chloride homopolymer has an average molecular weight as described herein. The plasticizer, stabilizer, and filler may be as described herein.

The present teachings also relate to a vinyl composition tile comprising a vinyl chloride homopolymer, a vinyl chloride-vinyl acetate copolymer, at least one plasticizer, at least one stabilizer, and at least one filler, wherein the vinyl chloride homopolymer is present in the formulation in an amount greater than 50% by weight of the combined amount of vinyl chloride homopolymer and a vinyl chloride-vinyl acetate copolymer.

It is to be understood that both the foregoing general description and the following detailed description are exemplary and explanatory only and are intended to provide a further explanation of the present invention, as claimed.

### DETAILED DESCRIPTION OF THE PRESENT INVENTION

In one aspect, the present invention relates to a composition comprising a vinyl chloride homopolymer and a vinyl copolymer, such as a vinyl chloride-vinyl acetate copolymer, wherein the vinyl chloride homopolymer is present in the composition in an amount greater than 50% by weight of the combined amount of vinyl chloride homopolymer and a vinyl copolymer, such as vinyl chloride-vinyl acetate copolymer (e.g., 60 wt. % or greater, 65 wt. % or greater, 70 wt. % or greater; 75 wt. % or greater). As a non-limiting example, the amount of vinyl chloride homopolymer can be 80% or greater by weight of the combined amount of vinyl chloride homopolymer and vinyl chloride-vinyl acetate copolymer, or may be 80%-99% by weight of the combined amount of vinyl chloride homopolymer and vinyl chloride-vinyl acetate copolymer or may be 80%-90% by weight of the combined amount of vinyl chloride homopolymer and vinyl chloride-vinyl acetate copolymer. The homopolymer can have any K-value. More than one type of homopolymer and/or vinyl polymer (e.g., copolymer) can be present in the composition.

In an additional embodiment of the present invention, the present invention relates to vinyl polymer compositions which contain less than 1% by weight or 0% by weight of vinyl copolymer, based on the combined amount of the vinyl chloride homopolymer and vinyl copolymer and/or other copolymer. Essentially, in this embodiment of the present invention, a vinyl polymer composition can be obtained without any copolymer or substantially no copolymer present.

The vinyl polymer compositions of the present invention can be used in a variety of applications, such as making vinyl polymer tiles (e.g., VCT) which can be used as surface coverings, such as floor coverings, wall coverings, and the like. The tiles can have any shape and/or size.

It has been found that problems of lack of cohesion that may arise when an increased amount of a conventional homopolymer is used to form a vinyl composition tile can be avoided by selecting a vinyl chloride homopolymer that has a lower molecular weight than a conventional homopolymer. In particular, the vinyl chloride homopolymer of the present invention may have K-value, as determined according to test method DIN 53726, of 54 or less, such as from about 47 to about 51, and from about 47 to about 53. The vinyl chloride homopolymer may have an inherent viscosity, as determined according to test method ASTM D1243 of from about 0.49 to about 0.60. The vinyl chloride homopolymer may have a relative viscosity of from about 1.247 to about 1.292.

As a non-limiting example, a particular homopolymer that has been found to be useful in the present invention is a vinyl chloride homopolymer resin provided by Georgia Gulf Corporation and designated by the product code “1050.” The 1050 homopolymer is a low molecular weight vinyl suspension resin having the following characteristics as set forth in Table I:

TABLE I

| | | |
|---|---|---|
| ASTM Cell Classification: | ASTM D1755 | GP1-16140 |
| Inherent Viscosity: | ASTM D1243 | 0.49 +/− 0.02 |
| Relative Viscosity: | | 1.55 |
| K-value | DIN53726 | 49 |
| Bulk density lbs/ft³: | ASTM D1895 | 33.0 min |
| Gms/cm³: | | 0.528 min |
| Percent Volatiles: | GGC 02-05-00 | 0.35 max |
| Syntron Contamination, | GGC 02-22-00 | 100 max |
| Particles/100 gms | | |
| Residual Vinyl Chloride | ASTM D3749 | 10.0 max |
| Monomer, ppm | | |
| Hunterlab Color, “L” | GGC 02-25-00 | 94.0 typical |
| “a” | | 0.60 typical |
| “b” | | 3.00 typical |
| Particle Size Distribution: | ASTM D1921 | |
| Percent retained on 40 mesh: | | 0 max |
| 60 mesh: | | 5 max |
| 200 mesh: | | 39 max |
| Pan | | 7 max |

While Table I provides properties for one specific homopolymer, it is to be understood that any vinyl chloride homopolymer resin can be used, such as a vinyl chloride homopolymer, having one or more of these properties or having one or more of these properties within 20% or within 10% of the property values set forth in Table I can be used in one or more embodiments of the present invention. The present invention is not limited to this particular homopolymer.

By contrast, a conventional homopolymer (Oxy Vinyl, LP, product code 185) that is used in vinyl composite tile formulations known in the art (that is, formulations in which the amount of homopolymer is less than the amount of copolymer) has a K-value of 56, an inherent viscosity of 0.68 and a relative viscosity of 1.82.

The vinyl copolymer can be any copolymer conventionally used to form vinyl compositions, such as vinyl composition tiles. The vinyl chloride-vinyl acetate copolymer may be any conventional vinyl chloride-vinyl acetate copolymer that can be used in vinyl resins and in vinyl composition tiles. A typical vinyl chloride-vinyl acetate copolymer may contain 12 to 14 wt. % vinyl acetate, although other amounts are possible. As a non-limiting example, a particular copolymer that has been found to be useful in the present invention is a vinyl chloride-vinyl acetate copolymer suspension resin provided by Petco (Petroquimica Colombiana E.A.) and designated by the product code “CR-80A.” The CR-80A copolymer has the following characteristics as set forth in Table II:

TABLE II

| | | CR-80A |
|---|---|---|
| Appearance | Test Method | White Powder |
| K-value | DIN 53726 | 50 ± 1 |
| Inherent Viscosity | ASTM D 1243 | 0.51-0.56 |
| Relative Viscosity | 1% by weight in | 1.58-1.66 |
| | Cyclohexanone | |
| | @ 25° C. | |
| Bulk Density, g/l | ASTM D 1895, | 600 min. |
| | Method A | |
| Particle Size | | |
| % passes through sieve 40 | ASTM D 1921 | 100% min. |
| % passes through sieve 200 | | 30% max. |
| Volatile Content, % | ASTM D 3030 | 2 max. |
| Bound acetate content, % | P-COP-01-08 | 13 ± 1 |
| Residual VCM content, ppm | ASTM D 3749 | 150, Typ. |

With respect to the properties set forth in Table II for the preferred copolymer, it is to be understood that any vinyl polymer (e.g., copolymer, terpolymer) can be used in the present invention. Preferably, the polymer has one or more of the properties set forth in Table II or has properties within 20% or within 10% of any one or more of the property values set forth in Table II.

The vinyl chloride homopolymer and the vinyl copolymer (e.g., vinyl chloride-vinyl acetate copolymer) can be combined or mixed in any order and by any method known in the art for mixing or combining vinyl resins. For example, the vinyl chloride homopolymer and the vinyl chloride-vinyl acetate copolymer can be mixed to form a preblend. Both the vinyl chloride homopolymer and the vinyl copolymer (e.g., vinyl chloride-vinyl acetate copolymer) can be in solid form, such as in the form of particles such as powders or pellets, that can be blended and combined by any suitable means, such as an extruder, mixer, and the like.

In another aspect, the present invention relates to a vinyl composition tile formulation that includes a vinyl chloride homopolymer, a vinyl copolymer (e.g., vinyl chloride-vinyl acetate copolymer), at least one plasticizer, at least one filler, and optionally, at least one stabilizer, wherein the vinyl chloride homopolymer is present in the formulation in an amount greater than 50% by weight of the combined amount of vinyl chloride homopolymer and a vinyl copolymer (e.g., vinyl chloride-vinyl acetate copolymer). The amount of vinyl chloride homopolymer in the vinyl composition tile formulation can be 80% or greater by weight of the combined amount of vinyl chloride homopolymer and vinyl copolymer (e.g., vinyl chloride-vinyl acetate copolymer), or may be 80%-99% by weight of the combined amount of vinyl chloride homopolymer and vinyl copolymer (e.g., vinyl chloride-vinyl acetate copolymer) or may be 80%-90% by weight of the combined amount of vinyl chloride homopolymer and vinyl copolymer (e.g., vinyl chloride-vinyl acetate copolymer). The vinyl chloride homopolymer has a molecular weight polymer that is lower than conventional vinyl chloride homopolymers, as described above. The vinyl composition tile formulation may also include other ingredients that are typically added to vinyl tile compositions, such as pigments or processing aids.

In one embodiment, a vinyl tile composition according to the present invention can contain from about 8 wt % to about 13 wt % of the composition comprising a vinyl chloride homopolymer and a vinyl copolymer (e.g., vinyl chloride-vinyl acetate copolymer) as described above, from about 80 wt % to about 90 wt % of filler, from about 0.2 wt % to about 0.8 wt % of the stabilizer, from about 3 wt % to about 6 wt % of the plasticizer and from about 0.2 wt % to about 2.0 wt % of other ingredients such as pigments or processing aids, based on the weight of the composition.

The filler may be any filler, including any conventional inorganic filler, that can be used in vinyl composition tile. Examples include, but are not limited to, hydrated alumina, magnesium carbonate, calcium sulfate, carbon black, flyash, cement dust, wood flour, cellulose-derived materials, ground rice hulls, clay, talc, calcium carbonate, barium sulfate, silicates, aluminum trihydrate, and the like. An inorganic filler typically provides dimensional stability and reduced elasticity to a vinyl composition tile, and may provide properties of fire resistance. As a non-limiting example, limestone (calcium carbonate with magnesium carbonate) may be used as the filler. A specific non-limiting example is dolomitic limestone (which can be screened), such as supplied by Specialty Minerals, Inc. under the product code DF-5025 and having a top mesh size of about 50 and a percent passing a 200 mesh sieve of about 25%. Other inorganic fillers that can be used include clay, talc, silicates, or aluminates. The filler may be in any physical form that allows it to be mixed or blended with the other ingredients to form a vinyl composition tile formulation that can be processed into a vinyl composition tile. Typically, the filler is in the form of particles.

A stabilizer typically provides heat stability and/or UV light stability to a vinyl composition. For example, a stabilizer may be used to minimize degradation and discoloration caused by exposure to heat and light, including conditions encountered in the manufacture of a vinyl composition tile. The stabilizer according to the present invention is preferably selected for effectiveness with the particular homopolymer-copolymer blend of the present invention and may be a calcium-zinc stabilizer. The zinc content of a calcium-zinc stabilizer may be greater that what is acceptable for a conventional homopolymer-copolymer blend. In particular, a calcium-zinc stabilizer containing 5.8 wt % or more zinc may be used, such as 6.0 wt % to about 10.0 wt % zinc. Specific non-limiting examples of zinc-calcium stabilizers are supplied by Chemson, Inc. under the product codes of PTP113 (5.8% zinc, 10.5% calcium by weight). Other examples of stabilizers include, but are not limited to, barium-cadmium stabilizers, barium-zinc stabilizers, organotin stabilizers, epoxidized soybean oils, and the like.

The plasticizer may be any plasticizer, including any conventional plasticizer, that can be used in vinyl resins. Examples include, but are not limited to, processing oils, polyesters, polyethers, polyether esters, and mixtures thereof. The plasticizer is typically in the form of an oily liquid that softens vinyl and adds flexibility to a composition containing a vinyl resin. For example, the plasticizer may be a phthalic diester or a mixture of phthalic diesters, such as a mixture of diisononyl phthalate (DINP) and butyl benzyl phthalate. A suitable plasticizer containing 10 wt % diisononyl phthalate and 90 wt % butyl benzyl phthalate, for example, is provided by Ferro Corp. designated with a product code of Santicizer-2076 (S-2076). Other examples of plasticizers include, but are not limited to, di(2-ethylhexyl) phthalate (DOP), diisooctyl phthalate (DIOP), ditridecyl phthalate (DTDP), dihexyl phthalate (DHP) and diiosdectyl phthalate (DIDP), and the like. The preferred selection criteria of plasticizers are to enhance flexibility, resiliency, and/or melt flow.

As an option, one or more coupling agents can be present in the vinyl composition tile formulation, such as a maleic anhydride. The coupling agent(s) is especially preferred when 1% or less by weight of vinyl copolymer is present, as explained in at least one embodiment of the present invention. Generally, the coupling agent can be present in an amount sufficient to permit sufficient coupling of the homopolymer and/or other components. Amounts can be, for instance, from about 5% by weight or less based on the weight of the homopolymer and vinyl copolymer present.

In a particular non-limiting example, the vinyl composition tile formulation may comprise at least one vinyl chloride homopolymer, at least one vinyl copolymer (e.g., vinyl chloride-vinyl acetate copolymer), at least one plasticizer, at least one stabilizer, and at least one filler, wherein the vinyl chloride homopolymer is present in the formulation in an amount that is greater than 50% by weight, such as from about 80% to about 90% by weight of the combined amount of vinyl chloride homopolymer and a vinyl copolymer (e.g., vinyl chloride-vinyl acetate copolymer), wherein the vinyl chloride homopolymer preferably has a K-value of 54 or less, and wherein the stabilizer can be a calcium-zinc stabilizer, for instance, having a zinc content of 5.8% or greater by weight.

The vinyl composition tile formulation may be in any physical form suitable for storage and/or for use to form a vinyl composition tile. For example, all of the ingredients except the plasticizer are typically solid ingredients and are typically in particulate or pellet form. Accordingly, these ingredients can be mixed in any order and by any method known in the art for combining particulate solids, and the plasticizer, which is typically a liquid, may be blended into the resulting mixture. The vinyl composition tile formulation may be premixed and stored for a period of time prior to use, or may be mixed just before, or even during, a process for manufacturing vinyl composition tile.

The vinyl composition tile formulation can optionally contain one or more colorants, modifying resins, cross-linking agents, antioxidants, foaming agents, tackifiers, and/or other conventional organic or inorganic additives commonly used in vinyl or in surface coverings, such as, but not limited to, UV-stabilizers, antistatic agents, thermal stabilizers, flame retardants, all used in amounts known to those skilled in the art. The components, additional layers and/or methods of U.S. Pat. Nos. 5,112,671; 4,614,680; 4,187,131; 4,172,169, 4,423,178; 4,313,866; and 5,380,794 can be used in the present application and these patents are incorporated in their entirety be reference herein.

For purposes of the present invention, the vinyl composition tile of the present invention generally contains the components present in the vinyl composition tile formulations described herein.

In another aspect, the present invention relates to a vinyl composition tile that is made from a vinyl composition tile formulation as described above. In particular, the present invention in this aspect relates to a vinyl composition tile comprising a vinyl chloride homopolymer, a vinyl copolymer (e.g., vinyl chloride-vinyl acetate copolymer), at least one plasticizer, at least one stabilizer, and at least one filler, wherein the vinyl chloride homopolymer is present in the formulation in an amount greater than 50% by weight of the combined amount of vinyl chloride homopolymer and a vinyl copolymer (e.g., vinyl chloride-vinyl acetate copolymer). The vinyl chloride homopolymer and vinyl copolymer (e.g., vinyl chloride-vinyl acetate copolymer), and the relative amounts thereof, plasticizer, stabilizer, and filler are all as described above. The vinyl composition tile may be made by any method known in the art for producing a vinyl composition tile from a vinyl composition tile formulation. For example, in a typical manufacturing process, a vinyl composition tile formulation may be heated and formed into a vinyl composition tile by rolling or calendering to a desired thickness. The resulting rolled or calendered vinyl composition may be cut into the form of tiles by any method known in the art. For example, rolled or calendered vinyl composition may be cut into standard 12″×12″ floor tiles by any known method. The thickness can be, for instance, ⅛″. The vinyl composition tile of the present invention may be combined with conventional flooring elements such as backing elements, adhesives and wear layers as well as a radiation curable urethane acrylate top coating.

For purposes of the present invention, the vinyl tiles of the present invention can be made in any manner typical for making vinyl tiles, such as vinyl composition tiles. The vinyl tiles of the present invention can be a through-chip vinyl tile or a vinyl tile made by a scratch method as those terms are understood by one skilled in the art. Generally, the tiles of the present invention can be made by taking the vinyl homopolymer(s) and vinyl copolymer(s) and mixing them together, such as with a Banbury mixer, kneader, or the like. The mixture of the vinyl homopolymer(s) and vinyl copolymer(s) can then be introduced to a two-roller mill, which are heated, such as at a temperature of from about 275° F. to about 350° F., though other temperatures are possible. This produces a sheeted material. At this point, accent colors, such as colorants or other accent material, can be optionally added, and then the sheeted material is cooled, such as to a temperature of 120° F. to about 150° F., though other temperatures are possible. Then, the sheeted material can be hammered or crushed into chips, which can then be subsequently blended and then reheated, such as to a temperature of 200° F. to about 250° F. This molten material is then passed through a two-roll mill and then calendared to form a sheeted material. The material is cooled, again, such as at a temperature of 100° F. to 130° F. A wax layer or other protective layer(s) can be applied and then the sheeted material is punched into tile form. As an option, the crushing or hammering of the material and re-blending and re-heating of the material is completely optional, depending upon whether one wishes to make a through-chip tile or a scratch tile.

With respect to the embodiment of the present invention wherein 1 wt % or less of copolymer is present in a vinyl polymer composition based on the combined amount of vinyl chloride homopolymer and copolymer, such as vinyl chloride-vinyl acetate copolymer, it is to be understood that this composition can include any of the ingredients discussed above for a vinyl tile composition, such as a stabilizer, plasticizer, and the like, in the amounts described herein. Further, it is to be understood that a vinyl composition tile can be made in the same manner as described above.

For purposes of the present invention, the tiles of the present invention preferably meet or exceed the specifications for vinyl composition tiles set forth in ASTM-F 1066-99 (2005). Further, the tiles of the present invention preferably have or exceed the product performance and specifications of conventional vinyl composition tiles.

The vinyl polymer composition tiles of the present invention can optionally be embossed with textures and/or designs, and this embossing can be in register with an optional printed design on the top of the tile surface. The tile can have no additional layer or coating on top or can have one or more layers above the tile and/or below the tile. For instance, the tiles of the present invention can have one or more wear layer(s) and/or top layer(s). Further, the tiles of the present invention can have a backing layer(s) or any intermediate-type layers. The various layers described in U.S. Pat. Nos. 6,291,078; 6,228,463; 6,218,001; 6,114,008; 5,961,903; 5,955,521; and 5,494,707 can be used, which are all incorporated in their entirety by reference herein. The tiles of the present invention can have wear-resistant particles or wear-resistant layers located on the tile and/or in the tile.

The present invention will be further clarified by the following examples, which are intended to be exemplary of the present invention.

### EXAMPLES

### Example 1

The following ingredients were mixed:

| | | |
|---|---|---|
| Limestone DF-5025 | 840.9 | gm |
| GG 1050 (vinyl chloride) homopolymer | 92.1 | gm |
| Petco CR-80A (vinyl chloride-vinyl acetate) copolymer | 23.0 | gm |
| Chemson EH-290 stabilizer | 4.5 | gm |

The mixer was put on a minimum setting and 39.4 gm of S-2076 plasticizer was added into the mixer during mixing. The mixing speed was then increased and mixing proceeded for 4 minutes.

Settings were adjusted in a lab roll mill so that both rolls were heated to 300° F., gaps in rolls were set to 0.125″, front roll speed was set to 45 rpm, and back roll speed was set to 32 rpm. The material obtained by the above mixing step was added to the nip of the mill, and was fused and milled into a solid sheet. The resulting sheet was easily removed from the roll and was in the form of a continuous sheet.

### Example 2

The following formulations were prepared (all amounts are parts by weight):

| | 40/60 | 20/80 | 10/90 | 0/100 |
|---|---|---|---|---|
| | ratio | ratio | ratio | ratio |
| PLASTICIZER S-2076 | 43.3 | 43.3 | 42.2 | 42.2 |
| Georgia Gulf 1050 homopolymer | 73.4 | 101.3 | 113.9 | 126.6 |
| Petco CR-80A CO-POLY | 53.2 | 25.3 | 12.7 | 0.0 |
| STABILIZER Chemson PTP113 | 5.0 | 5.0 | 5.0 | 5.0 |
| or EH 290 | | | | |
| LIMESTONE DF-5025 | 925.0 | 925.0 | 926.1 | 926.1 |
| TOTAL | 1100.0 | 1100.0 | 1100.0 | 1100.0 |

The ratio is weight ratio and refers to copolymer wt % to homopolymer wt %. In a trial run, the 20/80 wt. ratio formulation (that is, 20% copolymer, 80% homopolymer) (using Chemson EH 290 as the stabilizer) was used as the vinyl composition tile formulation in an industrial scale VCT manufacturing process. The trial run produced batches of finished product that were within normal specifications, and there were no adverse issues reported in the manufacturing process. In this example, the homopolymer and copolymer (if present) were mixed together in a Banbury mixer and introduced into a heated two-roller mill, wherein the temperature was from about 275° F. to about 350° F. The sheeted material was then formed and accent colors added to the sheeted material. The accent colors were polymer materials having the same homopolymer/copolymer weight ratio and included colorants or other accent materials for decorative purposes. This accent-sheeted material was then cooled to a temperature of approximately 120° F. to about 150° F. The material then was hammered or crushed into chips. These chips were then blended together and then re-heated at a temperature of approximately 200° F. to 250° F. This heated material was then subjected to a two-roller mill to form a sheeted material, which was then calendared to standard size specifications and then was cooled to a temperature of approximately 100° F. to 130° F. A wax layer was applied to the top of the sheeted material, and then the material was punched into tiles of desired dimensions, such as 12-inch×12-inch, with an overall gauge of 0.125 inch nominal.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present teachings will be apparent to those skilled in the art from consideration of the specification and practice of the present teachings disclosed herein. It is intended that the specification and examples be considered as exemplary only, with the true scope and spirit of the present invention being indicated by the following claims and equivalents thereof.

What is claimed is:

1. A composition comprising a vinyl chloride homopolymer and a vinyl chloride-vinyl acetate copolymer wherein the vinyl chloride homopolymer is present in the composition in an amount greater than 50% by weight of the combined amount of vinyl chloride homopolymer and a vinyl chloride-vinyl acetate copolymer.

2. The composition of claim 1, wherein the amount of vinyl chloride homopolymer is 80% or greater by weight of the combined amount of vinyl chloride homopolymer and vinyl chloride-vinyl acetate copolymer.

3. The composition of claim 1, wherein the amount of vinyl chloride homopolymer is 80%-99% by weight of the combined amount of vinyl chloride homopolymer and vinyl chloride-vinyl acetate copolymer.

4. The composition of claim 1, wherein the amount of vinyl chloride homopolymer is 80%-90% by weight of the combined amount of vinyl chloride homopolymer and vinyl chloride-vinyl acetate copolymer.

5. The composition of claim 1, wherein the vinyl chloride homopolymer has a K-value of 54 or less.

6. The composition of claim 1, wherein the vinyl chloride homopolymer has a K-value of 47 to 51.

7. A vinyl composition tile formulation comprising the composition of claim 1 and at least one plasticizer, at least one stabilizer, and at least one filler.

8. The vinyl composition tile formulation of claim 7, wherein the amount of vinyl chloride homopolymer is 80% or greater by weight of the combined amount of vinyl chloride homopolymer and vinyl chloride-vinyl acetate copolymer.

9. The vinyl composition tile formulation of claim 7, wherein the amount of vinyl chloride homopolymer is 80%-99% by weight of the combined amount of vinyl chloride homopolymer and vinyl chloride-vinyl acetate copolymer.

10. The vinyl composition tile formulation of claim 7, wherein the amount of vinyl chloride homopolymer is 80%-90% by weight of the combined amount of vinyl chloride homopolymer and vinyl chloride-vinyl acetate copolymer.

11. The vinyl composition tile formulation of claim 7, wherein the vinyl chloride homopolymer has a K-value of 54 or less.

12. The vinyl composition tile formulation of claim 7, wherein the vinyl chloride homopolymer has a K-value of 47 to 51.

13. The vinyl composition tile formulation of claim 7, wherein the plasticizer comprises at least one phthalic diester.

14. The vinyl composition tile formulation of claim 7, wherein the plasticizer comprises a mixture of diisononyl phthalate (DINP) and butyl benzyl phthalate (BBP).

15. The vinyl composition tile formulation of claim 7, wherein the stabilizer is a calcium-zinc stabilizer.

16. The vinyl composition tile formulation of claim 15, wherein the amount of zinc in the stabilizer is 5.8 wt. % or more by weight of the stabilizer.

17. The vinyl composition tile formulation of claim 7, wherein the filler is limestone.

18. The vinyl composition tile formulation of claim 7, containing from about 8 wt. % to about 13 wt. % of vinyl chloride homopolymer and vinyl chloride-vinyl acetate copolymer combined, from about 80 wt. % to about 90 wt. % of filler, from about 0.2 wt. % to about 0.8 wt. % of the stabilizer, and from about 3 wt. % to about 6 wt. % of the plasticizer.

19. A vinyl composition tile comprising the vinyl composition tile formulation of claim 7.

20. The vinyl composition tile formulation of claim 10, wherein the vinyl chloride homopolymer has a K-value of 50 or less, and wherein the stabilizer is a calcium-zinc stabilizer having a zinc content of 5.8 wt. % or greater by weight of the stabilizer.

21. A vinyl composition tile formed by a process comprising calendering the vinyl composition tile formulation of claim 20.

22. A composition comprising a vinyl chloride homopolymer and a vinyl chloride-vinyl acetate copolymer, wherein the vinyl chloride homopolymer has a K-value of 54 or less.

23. The composition of claim 22, wherein said vinyl chloride homopolymer has a K-value of from about 47 to about 51.

24. A vinyl composition tile formulation comprising at least one vinyl chloride homopolymer and 1 wt % or less of a copolymer based on the combined weight of the vinyl chloride homopolymer and copolymer, and at least one plasticizer and at least one filler.

25. The vinyl composition tile formulation of claim 24, further comprising at least one stabilizer.

26. The vinyl composition tile formulation of claim 24, wherein 0 wt % copolymer is present.

27. A vinyl composition tile comprising the vinyl composition tile formulation of claim 24.

28. A vinyl composition tile comprising the vinyl composition tile formulation of claim 25.

29. A vinyl composition tile comprising the vinyl composition tile formulation of claim 26.

30. A vinyl composition tile comprising a vinyl chloride homopolymer and a vinyl copolymer wherein the vinyl chloride homopolymer is present in the composition in an amount greater than 50% by weight of the combined amount of vinyl chloride homopolymer and a vinyl copolymer and at least one plasticizer, at least one stabilizer, and at least one filler.

31. The vinyl composition tile of claim 30, wherein the amount of vinyl chloride homopolymer is 80% or greater by weight of the combined amount of vinyl chloride homopolymer and vinyl copolymer.

32. The vinyl composition tile of claim 30, wherein the amount of vinyl chloride homopolymer is 80%-99% by weight of the combined amount of vinyl chloride homopolymer and vinyl copolymer.

33. The vinyl composition tile of claim 30, wherein the amount of vinyl chloride homopolymer is 80%-90% by weight of the combined amount of vinyl chloride homopolymer and vinyl copolymer.

34. The vinyl composition tile of claim 30, wherein the vinyl chloride homopolymer has a K-value of 54 or less.

35. The vinyl composition tile of claim 30, wherein the plasticizer comprises at least one phthalic diester.

36. The vinyl composition tile of claim 30, wherein the plasticizer comprises a mixture of diisononyl phthalate (DINP) and butyl benzyl phthalate (BBP).

37. The vinyl composition tile of claim 30, wherein the stabilizer is a calcium-zinc stabilizer.

38. The vinyl composition tile of claim 37, wherein the amount of zinc in the stabilizer is 5.8 wt. % or more by weight of the stabilizer.

39. The vinyl composition tile of claim 30, wherein the filler is limestone.

40. The vinyl composition tile of claim 30, containing from about 8 wt. % to about 13 wt. % of vinyl chloride homopolymer and vinyl chloride-vinyl acetate copolymer combined, from about 80 wt. % to about 90 wt. % of filler, from about 0.2 wt. % to about 0.8 wt. % of the stabilizer, and from about 3 wt. % to about 6 wt. % of the plasticizer.

41. The vinyl composition tile of claim 33, wherein the vinyl chloride homopolymer has a K-value of 50 or less, and wherein the stabilizer is a calcium-zinc stabilizer having a zinc content of 5.8 wt. % or greater by weight of the stabilizer.

42. A vinyl composition tile comprising at least one vinyl chloride homopolymer and 1 wt % or less of a copolymer based on the combined weight of the vinyl chloride homopolymer and copolymer, and at least one plasticizer and at least one filler.

43. The vinyl composition tile of claim 42, further comprising at least one stabilizer.

44. The vinyl composition tile of claim 42, wherein 0 wt % copolymer is present.

45. The vinyl composition tile of claim 42, further comprising at least one coupling agent.

46. The vinyl composition tile of claim 30, wherein said vinyl copolymer is vinyl chloride-vinyl acetate copolymer.

47. The vinyl composition tile of claim 30, wherein said vinyl copolymer is a vinyl chloride copolymer.
